(19) United States
(12) Patent Application Publication
(10) Pub. No.: US 2025/0389521 A1
(43) Pub. Date: Dec. 25, 2025

(54) PORTABLE LASER WEAPON

(71) Applicants: Avraham BOUBLI, Mevasseret Tsion (IL); Ethan LEVY, Jerusalem (IL)

(72) Inventors: Avraham BOUBLI, Mevasseret Tsion (IL); Ethan LEVY, Jerusalem (IL)

(21) Appl. No.: 19/245,703

(22) Filed: Jun. 23, 2025

(30) Foreign Application Priority Data
Jun. 24, 2024 (IL) 313890

(51) Int. Cl. F41H 13/00; G02B 7/28

(52) U.S. Cl. CPC F41H 13/0062; G02B 7/28

(57) ABSTRACT

A laser weapon system including a case including a battery, an inverter for charging the battery, a laser emitter, and a power control module for controlling provision of power from the battery to the laser emitter, a directional component for directing laser output to a specific direction and for focusing the laser output, an aiming component attached to the directional component for aiming the laser output, and a fiber optic cable attached to the case and to the directional component for transferring laser radiation from the case to the directional component, wherein the case is arranged for passive cooling of the laser emitter, and the aiming component includes a range finder for measuring a range to a target and providing the range to automatic laser focusing optics in the directional component for focusing the laser output at the measured range. Related apparatus and methods are also described.

### RELATED APPLICATION/S

This application claims the benefit of priority of Israel Patent Application No. 313890 filed 24 Jun. 2024, the contents of which are incorporated herein by reference in their entirety.

### TECHNOLOGICAL FIELD

The present disclosure, in some embodiments thereof, relates to a portable laser weapon and, more particularly, but not exclusively, to a human-portable laser weapon, to a drone-mounted laser weapon and to a vehicle-mounted laser weapon.

### BACKGROUND

Background art includes:
U.S. Pat. No. 9,303,958 to Conemac;
U.S. Pat. No. 10,900,755 to Paranto et al; and
U.S. Patent Application Publication No. 2022/042774 of Lee et al.

### BRIEF DESCRIPTION OF THE DRAWING(S)

Some embodiments of the disclosure are herein described, by way of example only, with reference to the accompanying drawings and images. With specific reference now to the drawings and image in detail, it is stressed that the particulars shown are by way of example and for purposes of illustrative discussion of embodiments of the disclosure. In this regard, the description taken with the drawings makes apparent to those skilled in the art how embodiments of the disclosure may be practiced.

In the drawings:

FIG. 1A is a simplified illustration of a human-portable laser weapon system according to an example;

FIG. 1B is a simplified illustration of a drone-mounted laser weapon system according to an example;

FIG. 1C is a simplified illustration of a vehicle-mounted laser weapon system according to an example;

FIG. 2A is a simplified isometric illustration of a case and components of the laser weapon system which are optionally packaged within the case according to an example;

FIG. 2B is a simplified illustration of the case of FIG. 2A according to an example;

FIG. 3A is a simplified isometric illustration of a directional component of the laser weapon system according to an example;

FIGS. 3B and 3C are simplified illustrations of the directional component of FIG. 3A;

FIG. 4A is a simplified illustration of components of a laser weapon system according to an example;

FIG. 4B is a simplified illustration of a method of focusing an output beam of a laser weapon system according to an example;

FIG. 4C is a simplified illustration of a method of focusing an output beam of a laser weapon system according to an example;

FIG. 4D, which is a simplified illustration of a method of focusing an output beam of a laser weapon system according to an example;

FIG. 5A is a simplified illustration of components of a laser weapon system according to an example;

FIG. 5B is a simplified illustration of a method of automatically correcting a direction of an output beam of a laser weapon system according to an example;

FIG. 5C is a simplified illustration of components for automatically correcting a direction of an output beam of a laser weapon system according to an example;

FIG. 5D is a simplified illustration of components for automatically correcting a direction of an output beam of a laser weapon system according to an example;

FIG. 6 is a simplified illustration of a human-portable laser weapon system according to an example;

FIGS. 7A and 7B show a first optical design and resultant spot diagram according to an example;

FIGS. 7C and 7D show a second optical design and resultant spot diagram according to an example;

FIGS. 7E and 7F show a third optical design and resultant spot diagram according to an example;

FIGS. 7G and 7H show a fourth optical design and resultant spot diagram according to an example;

FIGS. 8A and 8B are an image and a graph describing irradiance of a laser beam around a center of a beam according to the example of FIGS. 7G and 7H; and

FIG. 9 is a simplified block diagram showing control of a laser weapon system according to an example.

### DETAILED DESCRIPTION OF EXAMPLES

The present disclosure, in some embodiments thereof, relates to a potable laser weapon and, more particularly, but not exclusively, to a human-portable laser weapon.

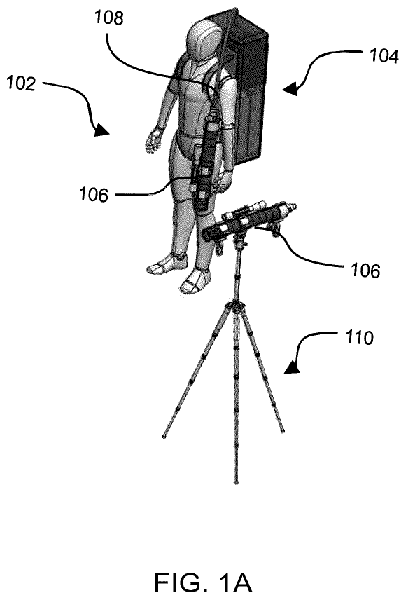

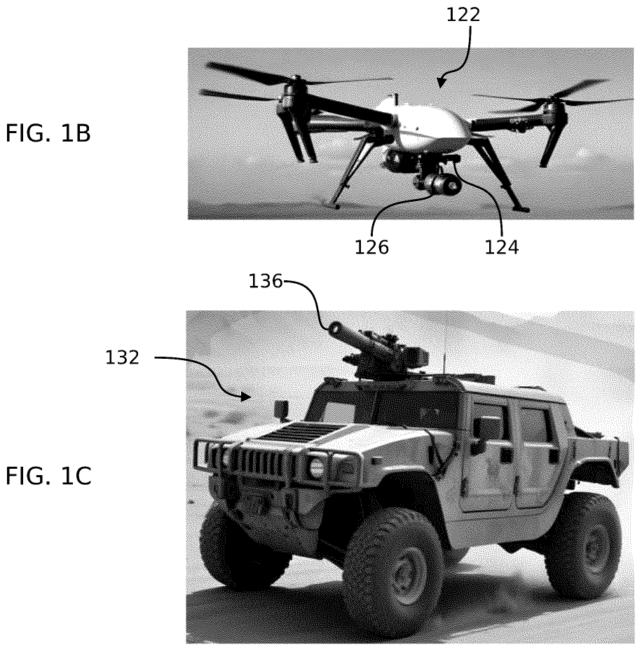

Reference is now made to FIG. 1A, which is a simplified illustration of a human-portable laser weapon system according to an example.

FIG. 1A is an isometric overview of examples of the human-portable laser weapon.

FIG. 1A shows a person 102 carrying an example of a laser weapon system, including a human-portable case 104 or backpack 104 for various components of the laser weapon system, a flexible fiber optic cable 108 for transferring laser emission to a directional component 106 for directing laser energy to a desired target.

In some examples, the fiber optic cable 108 may be a Large Mode Area (LMA) fiber optic cable.

In some examples, the fiber optic cable may optionally be a single mode optic fiber.

In some examples, the fiber optic cable may optionally be an active optic fiber, used as laser gain media, and/or for implementation as a fiber amplifier.

In some examples, the laser weapon system may optionally include double pumping of the optic fiber.

In some examples, double pumping, or dual-wavelength pumping, may be used.

Two different wavelengths of light may be used to excite the gain medium, enhancing the laser's performance and efficiency.

In some examples, the laser weapon system may optionally include a tripod 110 for mounting the directional component 106. The tripod may increase steadiness of aiming of the directional component 106.

Reference is now made to FIG. 1B, which is a simplified illustration of a drone-mounted laser weapon system according to an example.

FIG. 1B is an image of an example drone 122 on which is mounted a lightweight portable laser weapon 126.

In some examples a human-portable laser weapon is light enough to be mounted on a drone.

A drone 122 can provide a good line of sight to an over-the-hill target.

Many drones transmit a video image back to a drone operator.

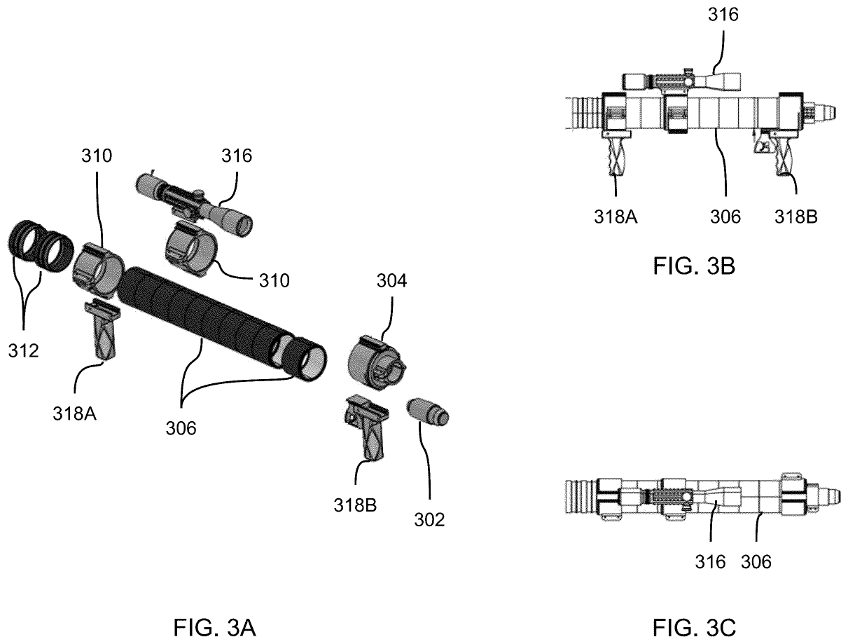

In some embodiments the drone 122 includes an aiming device 124 similar to any one of the aiming device types described below with reference to FIG. 3.

Reference is now made to FIG. 1C, which is a simplified illustration of a vehicle-mounted laser weapon system according to an example.

FIG. 1C is an image of an example vehicle 132 on which is mounted a lightweight portable laser weapon.

In some examples a human-portable laser weapon is light enough to be mounted on a vehicle.

A vehicle 132 can provide a larger power supply for more laser pulse emissions, that is, more laser shots, and/or more powerful laser shots.

Before explaining at least one embodiment of the disclosure in detail, it is to be understood that the disclosure is not necessarily limited in its application to the details of construction and the arrangement of the components and/or methods set forth in the following description and/or illustrated in the drawings and/or the Examples. The disclosure is capable of other embodiments or of being practiced or carried out in various ways.

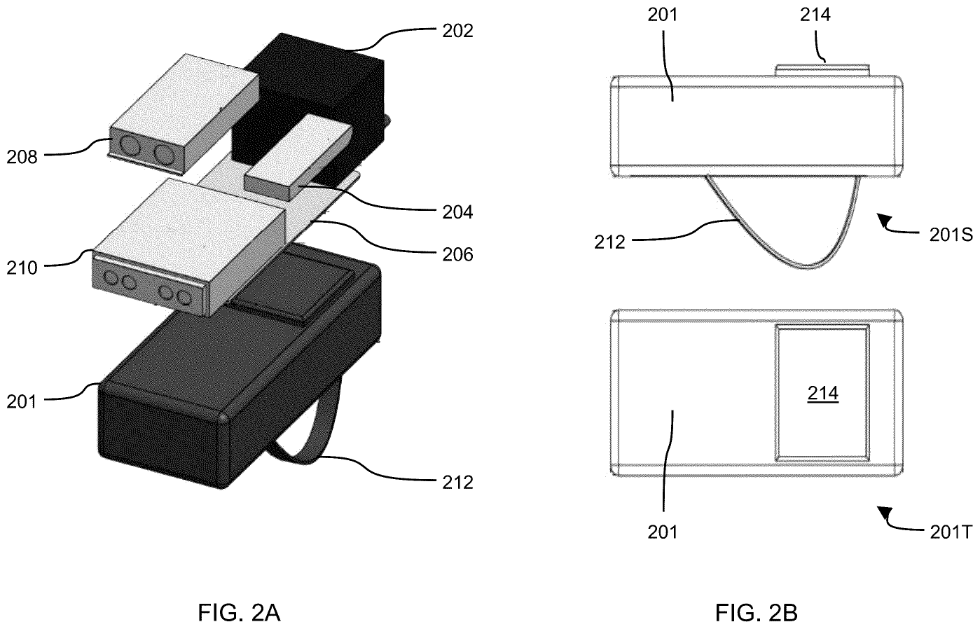

Reference is now made to FIG. 2A, which is a simplified isometric illustration of a case and components of the laser weapon system which are optionally packaged within the case according to an example.

FIG. 2A shows one example of a packing of components of the laser weapon system into a case 201 or backpack 201, by way of a non-limiting example similar to the backpack 104 shown in FIG. 1A. By way of a non-limiting example the backpack 201 may be a backpack with a 60-liter capacity.

Some of the components of the laser weapon system include:
a battery 202. By way of a non-limiting example the battery may be a Lithium battery, such as, by way of a non-limiting example, a Lithium Polymer or a Lithium Ion battery of 72 Volts, 80 ampere-hours;
an inverter 208, by way of a non-limiting example an inverter for converting 72V DC power from the battery 202 to 220V AC and provide the 220 VAC to a power supply 204. By way of a non-limiting example the inverter may be an 8,000 watt 220 VAC inverter;
a laser 210. By way of a non-limiting example the laser 210 may be a fiber laser with an air-cooled laser, such as a BFL-ACW10 laser. In some examples, the laser 210 unit may include circuitry to accept power from the power supply 204 and operate the laser 210;
a power supply 204. The power supply accepts power from the inverter 208 and provides power at a suitable voltage to components in the laser weapon system; and
an optional mount base 206 for mounting components such as the above-mentioned components.

In some examples, the backpack 201 may optionally include straps 212 for carrying the backpack 201.

In some examples, the laser 210 may optionally be a fiber laser, using a fiber optic.

In some examples, the laser 210 may optionally be passively cooled.

In some examples, the laser 210 may optionally be air-cooled by one or more electric fans.

In some examples, the laser 210 may optionally be cooled by a Thermo-Electric Cooler (TEC).

In some examples, heat pipes may optionally be used to conduct heat away from the laser 210 toward a cooling fan or a TEC.

In some examples, the laser 210 may optionally include an active optic fiber, used as laser gain media, and/or for implementation as a fiber amplifier.

In some examples, the laser 210 system may optionally include double pumping of the optic fiber.

In some examples, double pumping, or dual-wavelength pumping, may be used.

Two different wavelengths of light may be used to excite the gain medium, enhancing the laser's performance and efficiency.

Reference is now made to FIG. 2B, which is a simplified illustration of the case of FIG. 2A according to an example.

FIG. 2B shows a side view 201S and a top view 201T of the case 201 of FIG. 2A.

In some examples the case 201 may optionally include an opening 214.

In some examples the case 201 may optionally include an extension 214 which may enable one or more components to extend out of the generally boxy shape of the case 201.

The side view 201S also shows optional straps 212 for carrying the case 201 or backpack 201.

Reference is now made to FIG. 3A, which is a simplified isometric illustration of a directional component of the laser weapon system according to an example.

FIG. 3A shows one example of a directional component, by way of a non-limiting example similar to the directional component 106 shown in FIG. 1A.

Some sub-components of the directional component shown in FIG. 3A include:
an in-coupling optics coupler 302, which connects, mechanically and optically, a fiber optic cable such as the fiber optic cable 108 shown in FIG. 1A, to additional optics;
a first optional adaptor 304 for accepting the in-coupling optics coupler 302, receiving the in-coming laser radiation and transferring the radiation along an optic path through the directional component;
one or more tube section(s) 306. By way of a non-limiting example the tube section(s) 306 may be a lens tube section;
a second optional adaptor 310 receiving the laser radiation coming through the tube section(s) 306 and transferring the radiation along the optic path through the directional component. By way of a non-limiting example the second optional adaptor 310 may be a lens tube section;
one or more adjustable lens tube(s) 312 receiving the laser radiation coming through the second optional adaptor 310 and outputting the radiation from the directional component. By way of a non-limiting example the adjustable lens tube(s) 312 may optionally include automatically adjustable lenses for focusing the output beam. By way of a non-limiting example, the lenses of the adjustable lens tube(s) 312 may have a back focal length (BFL) of approximately 400-600 millimeter, or of approximately the length of the directional component;
an optional aiming device 316, such as a scope 316, which may optionally be attached to a body of the directional component of the laser weapon system. By way of a non-limiting example the optional aiming device 316 may be attached to the second optional adaptor 310; and
one or more optional grips 318A 318B attached to the body of the directional component of the laser weapon system.

In some examples the aiming device 316 may optionally include a rangefinder, optionally a laser rangefinder, or optionally an optical rangefinder.

In some examples the aiming device 316 may optionally include a digital camera and/or a digital camera display.

In some examples the aiming device 316 may optionally include a night vision device, or a combined day and night vision device.

In some examples the aiming device 316 may optionally include a night vision device at about 1.06 micron wavelength.

In some examples the aiming device 316 may optionally include a thermal night vision device.

In some examples the aiming device 316 may optionally include a flashlight optionally an infrared flashlight.

Reference is now made to FIGS. 3B and 3C, which are simplified illustrations of the directional component of FIG. 3A.

FIG. 3B shows a side view of the directional component of FIG. 3A. FIG. 3B also shows some sub-components of the directional component of FIG. 3A, referenced similarly to the references made in FIG. 3A.

FIG. 3C shows a top view of the directional component of FIG. 3A. FIG. 3C also shows some sub-components of the directional component of FIG. 3A, referenced similarly to the references made in FIG. 3A.

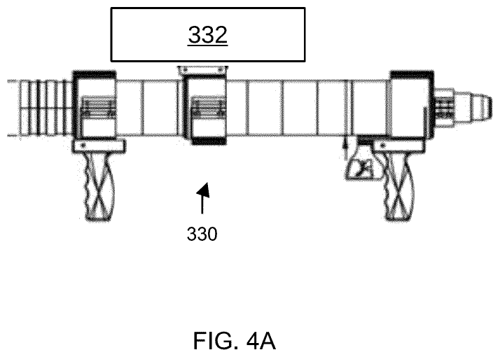

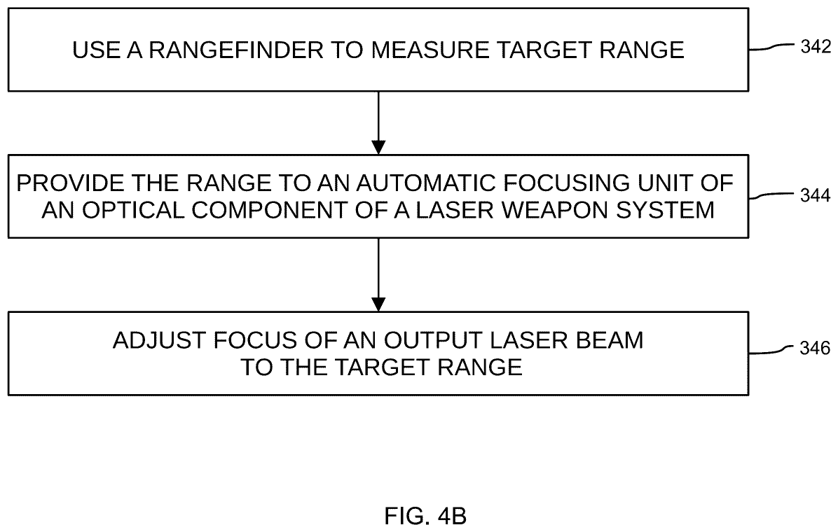

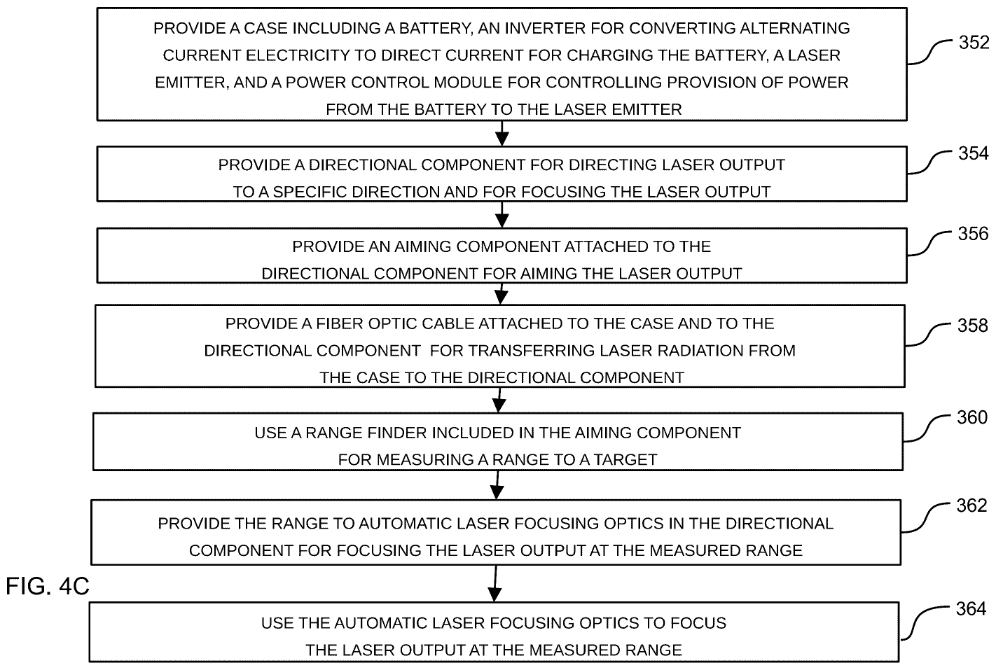

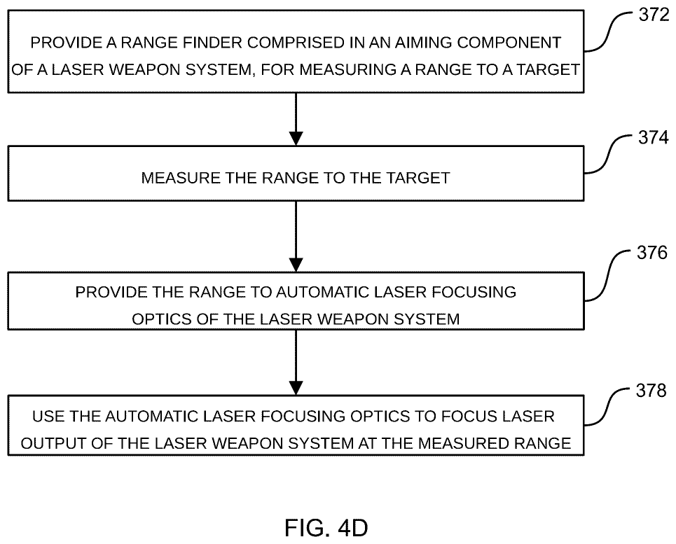

Reference is now made to FIG. 4A, which is a simplified illustration of components of a laser weapon system according to an example.

FIG. 4A shows a directional component 330, similar to the directional component 106 shown in FIG. 1A and the directional components shown in FIGS. 3A, 3B and 3C, and an aiming device 332 which includes a rangefinder, mounted on the directional component 330.

In some examples, the rangefinder of the aiming device 332 serves to measure a range to a target, potentially enabling focusing a laser beam emitted by the directional component 330 of the laser weapon system to focus laser power at a concentrated spot on the target, potentially enabling affecting the target with more energy in a shorter time than if the beam was not focused.

In some examples, the rangefinder of the aiming device 332 provides an electronic signal indicating the range to an automatic focusing unit in the directional component 330, to automatically perform the focusing at the measured range.

Reference is now made to FIG. 4B, which is a simplified illustration of a method of focusing an output beam of a laser weapon system according to an example.

The method of FIG. 4B includes:
using a rangefinder to measure target range to a target (342);
providing the range to an automatic focusing unit (344) of a directional component of a laser weapon system; and
adjusting focus of an output laser beam to the target range (346), thereby focusing the output beam of the laser weapon system at the target range.

Reference is now made to FIG. 4C, which is a simplified illustration of a method of focusing an output beam of a laser weapon system according to an example.

The method of FIG. 4C includes:
providing a case (352) including a battery, an inverter for converting alternating current electricity to direct current for charging the battery, a laser emitter, and a power control module for controlling provision of power from the battery to the laser emitter;
providing a directional component for directing laser output (354) to a specific direction and for focusing the laser output;
providing an aiming component (356) attached to the directional component for aiming the laser output;
providing a fiber optic cable (358) attached to the case and to the directional component for transferring laser radiation from the case to the directional component;
using a range finder (360) included in the aiming component for measuring a range to a target;
providing the range (362) to automatic laser focusing optics in the directional component for focusing the laser output at the measured range; and
using the automatic laser focusing optics to focus the laser output at the measured range (364).

Reference is now made to FIG. 4D, which is a simplified illustration of a method of focusing an output beam of a laser weapon system according to an example.

The method of FIG. 4D includes:
providing a range finder comprised in an aiming component of a laser weapon system, for measuring a range to a target (372);
measuring the range to the target (374);
providing the range to automatic laser focusing optics of the laser weapon system (376); and
using the automatic laser focusing optics to focus laser output of the laser weapon system at the measured range (378).

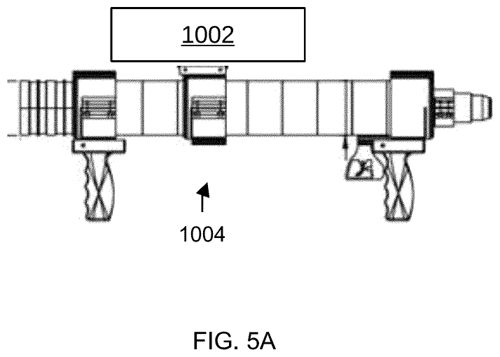

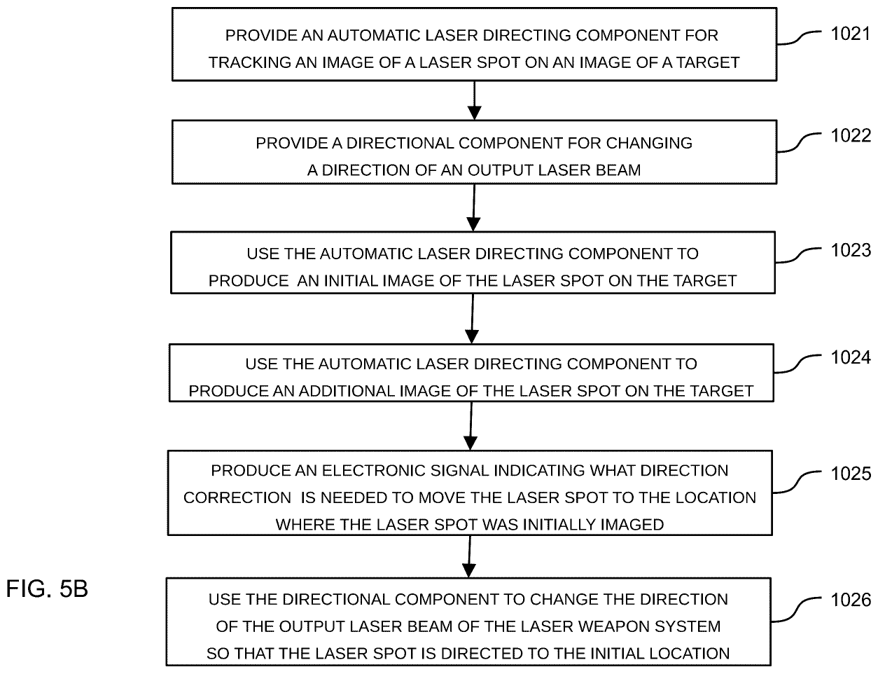

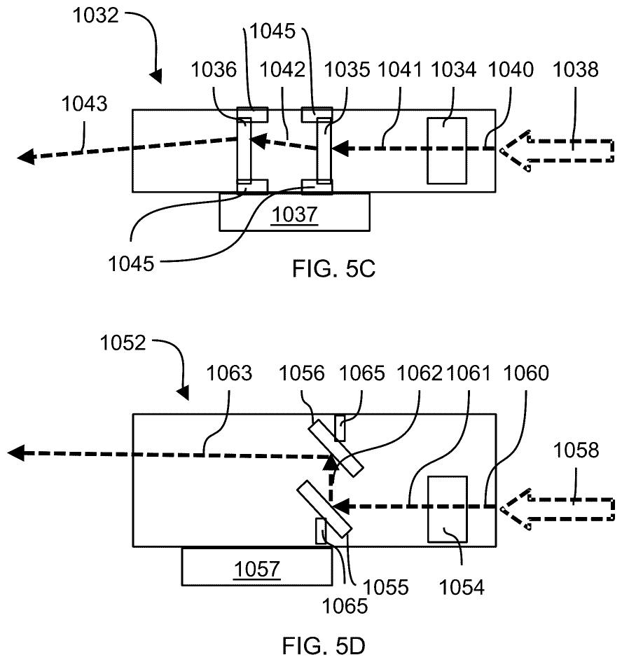

Reference is now made to FIG. 5A, which is a simplified illustration of components of a laser weapon system according to an example.

FIG. 5A shows a directional component 1004, and an automatic laser directing component 1002 mounted on the directional component 1004.

In some examples the directional component 1004 includes an inertial stabilization component which may optionally be activated. When activated, the inertial stabilization component stabilizes a direction of output of the laser beam output.

In some examples, the stabilization is a gyroscopic stabilization.

In some examples the stabilization is by a mirror in the optic path of the laser beam.

In some examples, the automatic laser directing component 1002 includes a digital camera, with a display for displaying a target of the laser weapon system, and when the laser is active, displaying the laser spot on the target. In some examples, the automatic laser directing component 1002 can image in the wavelength of the laser weapon system.

In some examples, the automatic laser directing component 1002 views the laser spot and produces an electronic signal or electronic data indicating where on the target the laser spot is located, or what direction correction is needed to move the laser spot to a location where the laser spot was initially imaged.

In some examples the laser weapon system includes an image processing component which optionally identifies a target and tracks the laser spot on the target.

In some examples the automatic laser directing component 1002 includes a laser rangefinder, by way of a non-limiting example such as described with reference to FIGS. 4A-4D.

In some examples, the directional component 1004 includes a mechanism for changing a direction of an output laser beam based on the electronic signal or electronic data indicating what direction correction is needed to move the laser spot to a location where the laser spot was initially imaged.

Reference is now made to FIG. 5B, which is a simplified illustration of a method of automatically correcting a direction of an output beam of a laser weapon system according to an example.

The method of FIG. 5B includes:
providing an automatic laser directing component comprised in an aiming component of a laser weapon system, for tracking an image of a laser spot on an image of a target and producing an electronic signal indicating what direction correction is needed to move the laser spot to an initial location where the laser spot was initially imaged;
providing a directional component for changing a direction of an output laser beam of the laser weapon system based on the electronic signal;
using the automatic laser directing component to produce an initial image of the laser spot on the target;
using the automatic laser directing component to produce an additional image of the laser spot on the target;
producing an electronic signal indicating what direction correction is needed to move the laser spot from the location in the additional image to the location where the laser spot was initially imaged; and
using the directional component to change the direction of the output laser beam of the laser weapon system so that the laser spot is directed to the initial location.

Reference is now made to FIG. 5C, which is a simplified illustration of components for automatically correcting a direction of an output beam of a laser weapon system according to an example.

FIG. 5C shows a directional component 1032 which includes an optional focusing or autofocusing component 1034 and direction changing components 1035 1036.

A laser beam 1038 enters the directional component 1032, in some examples passes through the optional focusing or autofocusing component 1034 coming out as a laser beam 1041 and enter a section for automatically correcting a direction of an output beam of a laser weapon.

In some examples the first direction changing component 1035 optionally changes direction of the laser beam 1041 in one direction, for example in the Y direction, producing a laser beam 1042 in a changed direction, and the second direction changing component 1036 optionally changes direction of the laser beam 1042 in another direction, for example in the X direction producing an output laser beam 1043 in a changed direction.

By way of a non-limiting example, the direction changing components 1035 1036 may be optical wedges 1035 1036, which change direction of a laser beam which passes through them by a small angle. The wedges 1035 1036 are controllable to tilt and change the direction of the laser beam by a controllable amount.

In some examples, the tilt of the direction changing components 1035 1036 is optionally controlled by one or more Voice Coil Motors 1045, which can provide rapid direction changes of the output beam in response to rapid changes in control signals from an automatic laser directing component such as, by way of a non-limiting example, the automatic laser directing component 1002 shown in FIG. 5A.

In various examples, various direction changing optical components may be used, such as, by way of some non-limiting examples: optical wedges, mirrors, micro-electromechanical systems (MEMS), piezo-controlled mirrors, and additional components as are known in the art.

In various examples, various control actuators for controlling the optical direction changing components, such as, by way of some non-limiting examples, Voice Coil Motors and linear stage motors.

Reference is now made to FIG. 5D, which is a simplified illustration of components for automatically correcting a direction of an output beam of a laser weapon system according to an example.

FIG. 5D shows a directional component 1052 which includes an optional focusing or autofocusing component 1054 and direction changing components 1055 1056.

A laser beam 1058 enters the directional component 1052, in some examples passes through the optional focusing or autofocusing component 1054 coming out as a laser beam 1061 and enter a section for automatically correcting a direction of an output beam of a laser weapon.

In some examples the first direction changing component 1055 optionally changes direction of the laser beam 1061 in one direction, for example in the Y direction, producing a laser beam 1062 in a changed direction, and the second direction changing component 1056 optionally changes direction of the laser beam 1062 in another direction, for example in the X direction producing an output laser beam 1063 in a changed direction.

By way of a non-limiting example, the direction changing components 1055 1056 may be mirrors 1055 1056, which change direction of a laser beam which reflects from them. The mirrors 1055 1056 are controllable to tilt and change the direction of the laser beam by a controllable amount.

In some examples, the tilt of the direction changing components 1055 1056 is optionally controlled by one or more Voice Coil Motors 1065, which can provide rapid direction changes of the output beam in response to rapid changes in control signals from an automatic laser directing component such as, by way of a non-limiting example, the automatic laser directing component 1002 shown in FIG. 5A.

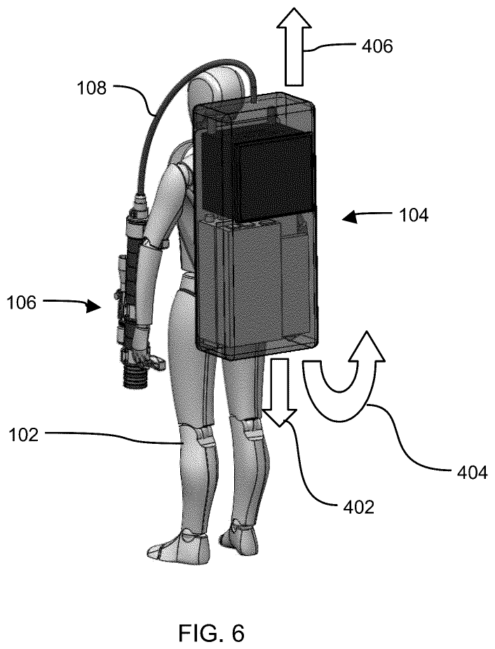

Reference is now made to FIG. 6, which is a simplified illustration of a human-portable laser weapon system according to an example.

FIG. 6 is an isometric view from a back side of an example of the human-portable laser weapon.

FIG. 6 shows a person 102 carrying an example of a laser weapon system, including a human-portable case 104 or backpack 104 for various components of the laser weapon system, a fiber optic cable 108 for transferring laser emission to a directional component 106 for directing laser energy to a desired target.

In some examples the case 104 or backpack 104 includes one or more openings or vents for dissipating heat.

In some examples the heat may be dissipated downward 402 404. In some examples the heat may be dissipated upward 406. In some examples the heat may be dissipated in other directions, not specifically shown in FIG. 6.

In some examples the heat may optionally be passively dissipated.

In some examples, the heat may optionally be dissipated by one or more electric fans.

A weight of an experimental example of a laser weapon system is 30 kilograms. Such a relatively lightweight system can be used to destroy various battlefield targets such as, by way of some non-limiting examples, drones or small Unmanned Aerial Vehicles, or to blind observation systems or even soldiers.

Various embodiments and aspects of the present disclosure as delineated hereinabove and as claimed in the claims section below find experimental and calculated support in the following examples.

### EXAMPLES

Reference is now made to the following examples, which together with the above descriptions illustrate some embodiments of the disclosure in a non-limiting fashion.

In one example implementation a laser weapon system was assembled having the following features:

The laser wavelength was 1064 nanometers [nm].

The fiber optic cable was LMA.

M² was 1.3.+/−30% It is noted that the parameter M², also known as the beam propagation ratio or beam quality factor is a measure of laser beam quality. It represents the degree of variation of a beam from an ideal Gaussian beam. The M² value for a laser beam is widely used in the laser industry as a specification, and its method of measurement is regulated as an ISO standard.

The laser power in the example was 500 Watts Continuous Wave (CW), but can be much higher, e.g. 1 kiloWatt (kW), 2 kW, 5 kW, 6 kW, 10 kW, and up to 30 kW CW.

Table 1A below shows details of calculated values for two example implementations:

TABLE 1A

| | | | | | | | | |
|---|---|---|---|---|---|---|---|---|
| Wavelength | 1.064 | μm | | | 1.064 | μm | | |
| Laser Power | 500 | W | | | 500 | W | | |
| Core diameter | 20 | μm | | | 20 | μm | | |
| M² | 1.3 | | | | 1.3 | | | |
| Fiber [NA] | 0.0339 | | | | 0.0339 | | | |
| Lens EFL | 0.6 | m | | | 0.4 | m | | |
| (effective focal | | | | | | | | |
| length) | | | | | | | | |
| Collimation | 2.03E−02 | m | | | 1.35E−02 | m | | |
| Waist | | | | | | | | |
| Output lens | 0.063 | m | 2.5 | inch | 0.042 | m | 1.7 | inch |
| diameter | | | | | | | | |
| Output power | 32.8 | W/cm² | | | 73.7 | W/cm² | | |
| density | | | | | | | | |
| Full | 43.3 | μrad | | | 65.0 | μrad | | |
| divergence @ | | | | | | | | |
| 1/e² (~97% | | | | | | | | |
| energy) | | | | | | | | |
| Distance to | 1,000 | m | 1 | km | 500 | m | 0.5 | km |
| target | | | | | | | | |
| Beam | 84.0 | mm | | | 59.6 | mm | | |
| diameter on | | | | | | | | |
| target @ 1/e² | | | | | | | | |
| Power density | 7.7 | W/cm² | 0.01 | kW/cm² | 15.2 | W/cm² | 0.02 | kW/cm² |
| on target | | | | | | | | |

TABLE 1B

| | | | | | | | | |
|---|---|---|---|---|---|---|---|---|
| Wavelength | 1.064 | μm | | | 1.064 | μm | | |
| Laser Power | 5000 | W | | | 5000 | W | | |
| Core | 20 | μm | | | 30 | μm | | |
| diameter | | | | | | | | |
| M² | 1.3 | | | | 1.3 | | | |
| Fiber [NA] | 0.0339 | | | | 0.0226 | | | |
| Lens EFL | 0.6 | m | | | 0.6 | m | | |
| (effective | | | | | | | | |
| focal length) | | | | | | | | |
| Collimation | 2.03E−02 | m | | | 1.35E−02 | m | | |
| Waist | | | | | | | | |
| Output lens | 0.063 | m | 2.5 | inch | 0.042 | m | 1.7 | inch |
| diameter | | | | | | | | |
| Output | 327.6 | W/cm² | | | 737.1 | W/cm² | | |
| power | | | | | | | | |
| density | | | | | | | | |
| Full | 43.3 | μrad | | | 65.0 | μrad | | |
| divergence | | | | | | | | |
| @ 1/e² | | | | | | | | |
| (~97% | | | | | | | | |
| energy) | | | | | | | | |
| Distance to | 1,000 | m | 1 | km | 1,000 | m | 1 | km |
| target | | | | | | | | |
| Beam | 84.0 | mm | | | 92.1 | mm | | |
| diameter on | | | | | | | | |
| target @ 1/e² | | | | | | | | |
| Power | 76.7 | W/cm² | 0.08 | kW/cm² | 63.8 | W/cm² | 0.06 | kW/cm² |
| density on | | | | | | | | |
| target | | | | | | | | |

It is noted that a laser weapon operating at a wavelength of 1.06 microns produces a laser spot that is invisible to an unaided human eye, at least until the laser spot has produced some damage.

Table 2 below shows calculated values for an example design:

TABLE 2

| Distance to | | Output beam diameter | Beam diameter at |
|---|---|---|---|
| target | Lens EFL | (3 × Waist) | target (2 × Waist)* |
| 0.5 [km] | 0.6 [m] | 63 [mm] (2.5″) | 62.3 [mm] |
| 1 [km] | 0.6 [m] | 63 [mm] (2.5″) | 84 [mm] |

*It is noted that at 2 × Waist, that is, 2 times a waist diameter of the laser beam, the beam contains ~86% of the output power

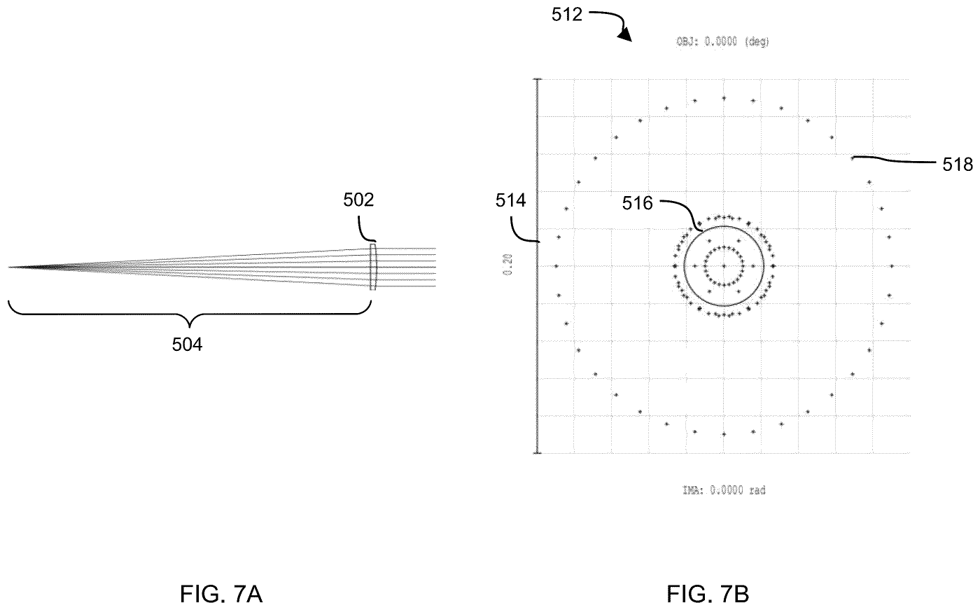

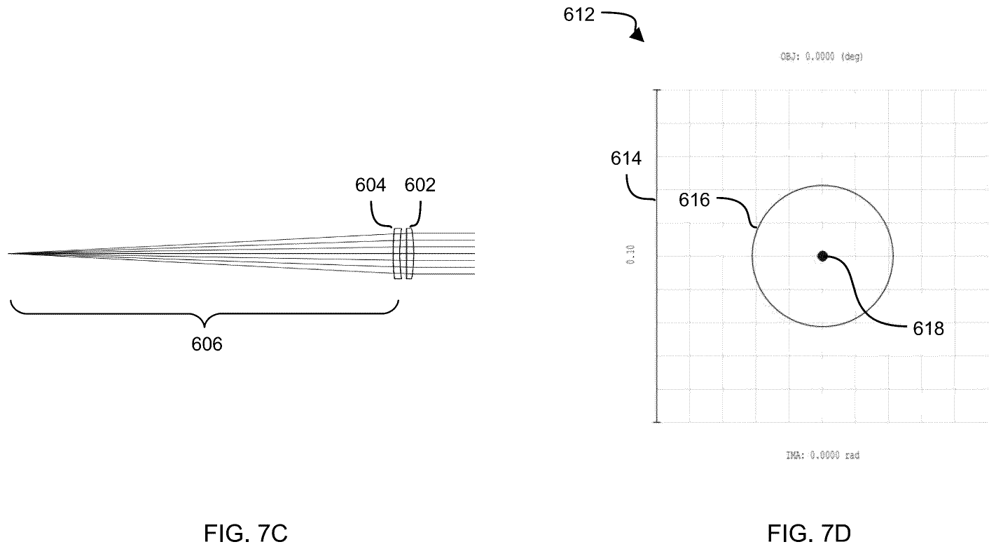

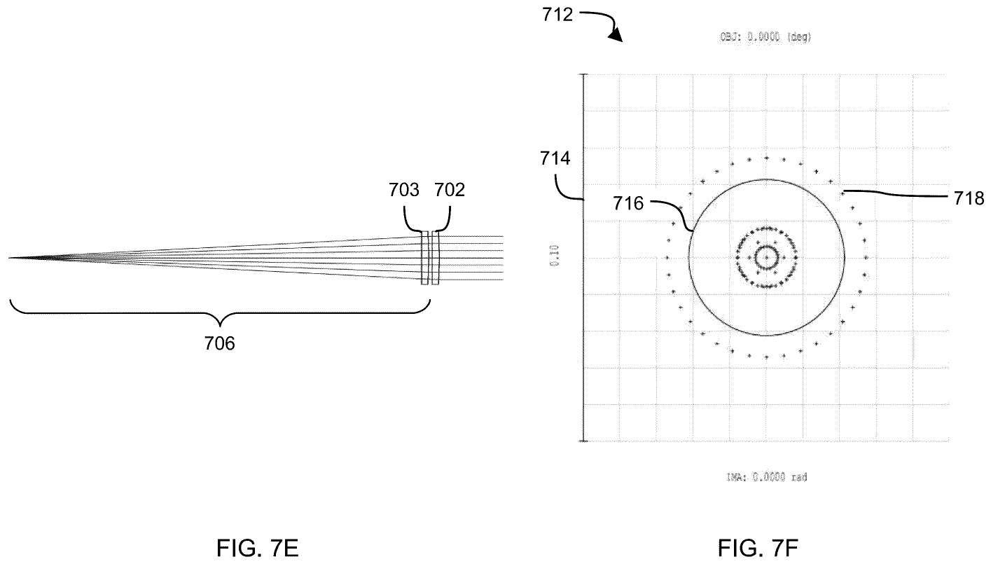

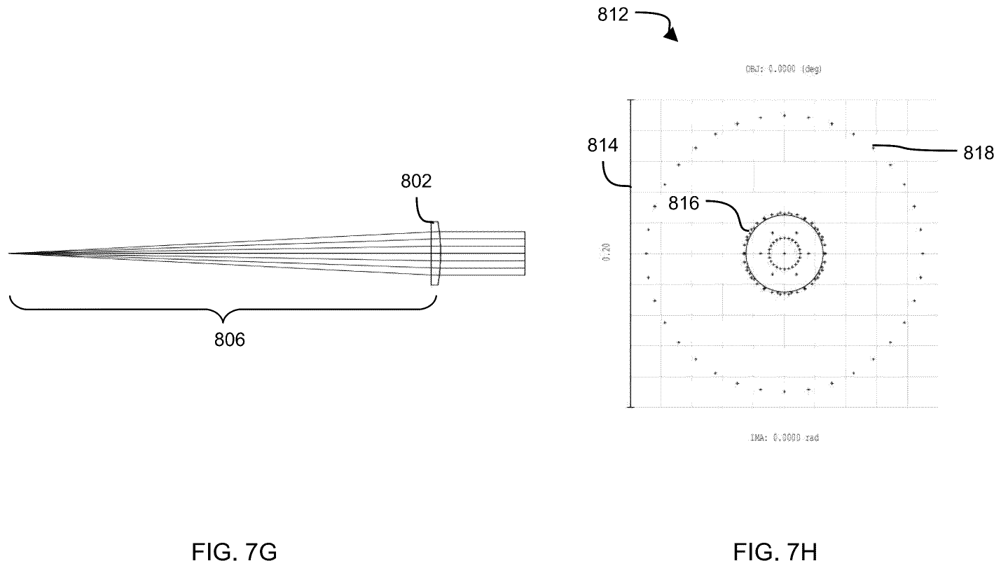

Reference is now made to FIGS. 7A and 7B, which are drawings illustrating a first optical design and resultant spot diagram according to an example.

FIG. 7A shows a first optical design including a spherical plano-convex (PCX) lens 502 with an effective focal length (EFL) 504 of 600 meters [m].

In the example of FIGS. 7A and 7B the lens is optionally a fused silica lens.

FIG. 7B shows a spot diagram 512, with a scale bar 514 showing an extent of 0.20 milliradians (mrad), that is +/−10 mrad relative to a chief ray of a beam produced by the optical design of FIG. 7A.

FIG. 7B shows some characteristics of the beam:
an Airy radius 516 of 0.02131 mrad;
a GEO radius 518, which includes substantially all of the laser energy, of 0.090 mrad; and
an RMS radius (not shown) of 0.051 mrad.

Reference is now made to FIGS. 7C and 7D, which are drawings illustrating a second optical design and resultant spot diagram according to an example.

FIG. 7C shows a second optical design including a first spherical plano-convex (PCX) lens 602, and a second spherical positive meniscus lens 604. The optical design of FIG. 7C can optionally have a combined effective focal length 606 of 500 meters [m].

In the example of FIGS. 7C and 7D the lenses are optionally a fused silica lens.

FIG. 7D shows a spot diagram 612, with a scale bar 614 showing an extent of 0.10 mrad, that is +/−5 mrad relative to a chief ray of a beam produced by the optical design of FIG. 7C.

FIG. 7D shows some characteristics of the beam:
an Airy radius 616 of 0.02127 mrad; and
a GEO radius 618 of 0.001 mrad.

Reference is now made to FIGS. 7E and 7F, which are drawings illustrating a third optical design and resultant spot diagram according to an example.

FIG. 7E shows a third optical design including two similar spherical plano-convex (PCX) lenses 602 604 with a combined effective focal length (EFL) 704 of 500 meters [m].

In the example of FIGS. 7E and 7F the lenses are optionally fused silica lenses.

FIG. 7F shows a spot diagram 712, with a scale bar 714 showing an extent of 0.10 milliradians (mrad), that is +/−5 mrad relative to a chief ray of a beam produced by the optical design of FIG. 7E.

FIG. 7F shows some characteristics of the beam:
an Airy radius 716 of 0.02128 mrad;
a GEO radius 718 of 0.027 mrad; and
an RMS radius (not shown) of 0.016 mrad.

Reference is now made to FIGS. 7G and 7H, which are drawings illustrating a fourth optical design and resultant spot diagram according to an example.

FIG. 7G shows a fourth optical design including a spherical plano-convex (PCX) lens 802 with a focal length of 500 meters [m].

FIG. 7H shows a spot diagram 812, with a scale bar 814 showing an extent of 0.20 milliradians (mrad), that is +/−10 mrad relative to a chief ray of a beam produced by the optical design of FIG. 7G.

FIG. 7H shows some characteristics of the beam:
an Airy radius 816 of 0.02508 mrad;
a GEO radius 818 of 0.090 mrad; and
an RMS radius (not shown) of 0.051 mrad.

In the example of FIGS. 7G and 7H the lens 802 is optionally fused silica lenses.

In the example of FIGS. 7G and 7H, for M²=1, a diameter of a spot at the target containing 80% of the beam power is 60 millimeters, and a diameter of the spot containing 88% of the beam power is 80 millimeters.

In the example of FIGS. 7G and 7H, for M²=1.3, a diameter of a spot at the target containing 80% of the beam power is 70 millimeters, and a diameter of the spot containing 88% of the beam power is 90 millimeters.

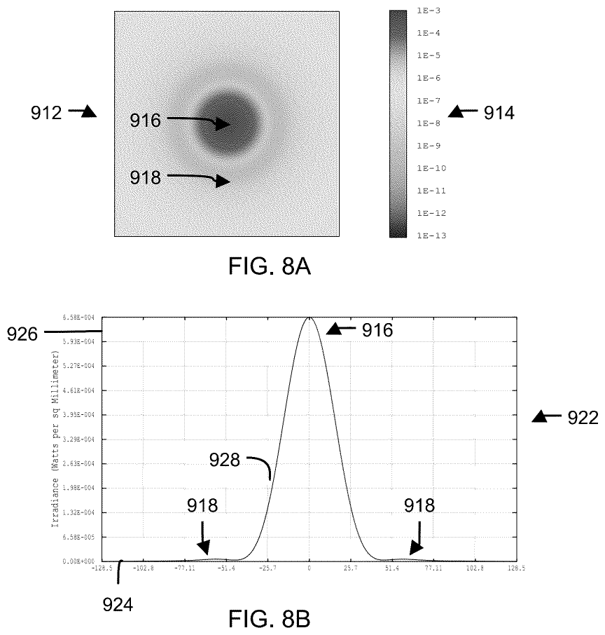

Reference is now made to FIGS. 8A and 8B, which are an image and a graph describing irradiance of a laser beam around a center of a beam according to the example of FIGS. 7G and 7H.

FIG. 8A includes a color image 912 showing logarithmic values of irradiance, and a legend 914 showing the logarithmic values of the colors in the color image 912. FIG. 8A shows a main beam 916 and a side lobe 918.

FIG. 8B is a graph 922 describing irradiance of a laser beam. FIG. 8B has an X axis 924 showing distance from the center of the beam in units of millimeters and a Y-axis 926 showing irradiance using units of Watts/mm².

The center of the graph 922 shows a peak irradiance of 6.5843 E-04 Watts/mm².

The center of the graph 922 shows the main beam 916 and the side lobe 918 also shown in FIG. 8A.

### Control of the Laser Weapon System

In some examples, control of whether to trigger laser output is provided by a switch or trigger built into the laser weapon itself.

In some embodiments the switch or trigger are manually operated by an operator pressing the switch or trigger.

In some embodiments the switch or trigger of the laser weapon may optionally be controlled by the laser weapon receiving a transmitted signal which may block providing the laser output.

In some embodiments the switch or trigger of the laser weapon may optionally be controlled by the laser weapon receiving a transmitted signal which may be needed to enable providing the laser output.

In some embodiments the laser weapon may include a specific identification code or number corresponding to a specific identification code or number present in the transmitted signal, so that the transmitted signal can control the laser weapon associated with the specific identification code or number.

Use of such a transmitted signal may optionally provide one or more of the following benefits:
synchronization of laser output from several laser weapon systems aimed at one target;
blocking of one or more laser weapon systems for safety purposes; and
blocking of a laser weapon system which has been taken over by the enemy from producing laser output.

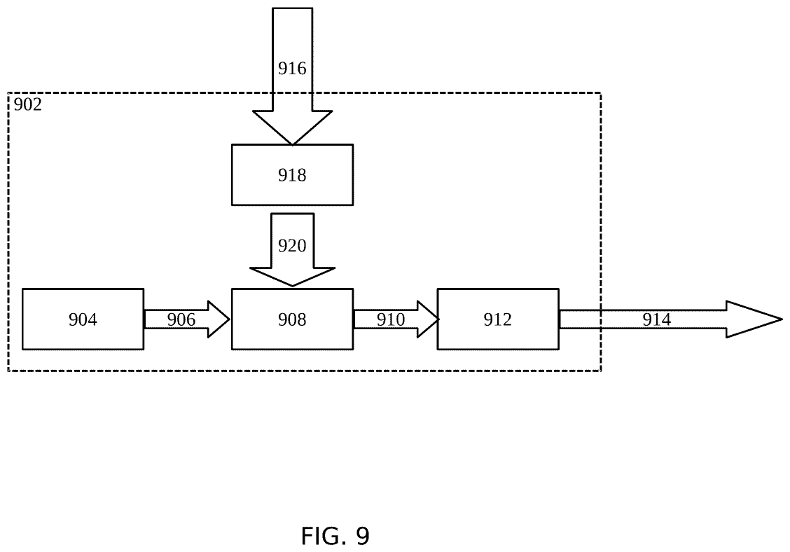

Reference is now made to FIG. 9, which is a simplified block diagram showing control of a laser weapon system according to an example.

FIG. 9 shows a laser weapon 902, with a switch 904 or trigger 904 which provides an activation signal 906 to a laser control module 908.

In some examples the laser control module 908 produces an activation signal 910 to a laser 912, which produces laser output 914.

In some examples the laser weapon 902 also includes an optional receiver 918, for receiving an external signal 916, and producing a signal 920 which may also act as input to the laser control module 908.

In some examples the signal 920 acts as a blocking signal, which blocks the laser control module 908 from controlling the laser 912 to produce the laser output 914.

In some examples the signal 920 acts as an enabling signal, which enables and/or causes the laser control module 908 to control the laser 912 to produce the laser output 914.

[symbol]

### SUMMARY

### Example 1

A laser weapon system including a case including a battery, an inverter for converting alternating current electricity to direct current for charging the battery, a laser emitter, and a power control module for controlling provision of power from the battery to the laser emitter, a directional component for directing laser output to a specific direction and for focusing the laser output, an aiming component attached to the directional component for aiming the laser output, and a fiber optic cable attached to the case and to the directional component for transferring laser radiation from the case to the directional component, wherein the case is arranged for passive cooling of the laser emitter, and the aiming component includes a range finder for measuring a range to a target and providing the range to automatic laser focusing optics in the directional component for focusing the laser output at the measured range.

### Example 2

A laser weapon system according to Example 1 including an automatic laser directing component producing an electronic signal indicating what correction is needed to move the laser output to a location where the laser output was initially imaged.

### Example 3

A laser weapon system according to Example 2 arranged to receive the electronic signal and wherein the directional component includes components for automatically correcting a direction of the laser output based on the electronic signal.

### Example 4

A laser weapon system according to any one of Examples 1-3 wherein the case weighs less than 30 kilograms.

### Example 5

A laser weapon system according to any one of Examples 1-4 wherein the output laser power is at least 1 kilo-Watt [kW] Continuous Wave (CW).

### Example 6

A laser weapon system according to any one of Examples 1-5 wherein the case is arranged for passive cooling of the laser emitter by an electric fan blowing air out of a bottom portion of the case when the case is carried on an operator's back.

### Example 7

A laser weapon system according to any one of Examples 1-6 wherein the aiming component includes a digital camera and a display.

### Example 8

A laser weapon system according to any one of Examples 1-7 wherein the aiming component includes a night vision device.

### Example 9

A laser weapon system according to any one of Examples 1-8 wherein the aiming component includes a flashlight.

### Example 10

A laser weapon system according to any one of examples 1-9 and further including a laser control module for controlling whether the laser emitter produces the laser output, and wherein the laser control module receives a signal from a laser trigger in the laser weapon system and from a receiver in the laser weapon system, and controls whether the laser emitter produces the laser output based on a combination of the signal from the laser trigger and a signal from the receiver.

### Example 11

A method of using a laser weapon system including providing a case including a battery, an inverter for converting alternating current electricity to direct current for charging the battery, a laser emitter, and a power control module for controlling provision of power from the battery to the laser emitter, providing a directional component for directing laser output to a specific direction and for focusing the laser output, providing an aiming component attached to the directional component for aiming the laser output, providing a fiber optic cable attached to the case and to the directional component for transferring laser radiation from the case to the directional component, using a range finder included in the aiming component for measuring a range to a target, providing the range to automatic laser focusing optics in the directional component for focusing the laser output at the measured range, and using the automatic laser focusing optics to focus the laser output at the measured range.

### Example 12

A method of using a laser weapon system including providing a range finder included in an aiming component of a laser weapon system, for measuring a range to a target, measuring the range to the target, providing the range to automatic laser focusing optics of the laser weapon system, and using the automatic laser focusing optics to focus laser output of the laser weapon system at the measured range.

### Example 13

A method of using a laser weapon system including providing an automatic laser directing component included in an aiming component of a laser weapon system, for tracking an image of a laser spot on an image of a target and producing an electronic signal indicating what direction correction is needed to move the laser spot to an initial location where the laser spot was initially imaged, providing a directional component for changing a direction of an output laser beam of the laser weapon system based on the electronic signal, using the automatic laser directing component to produce an initial image of the laser spot on the target, using the automatic laser directing component to produce an additional image of the laser spot on the target, producing an electronic signal indicating what direction correction is needed to move the laser spot from the location in the additional image to the location where the laser spot was initially imaged, and using the directional component to change the direction of the output laser beam of the laser weapon system so that the laser spot is directed to the initial location.

As such, those skilled in the art to which the present invention pertains, can appreciate that while the present invention has been described in terms of preferred examples, the concept upon which this disclosure is based may readily be utilized as a basis for the designing of other structures, systems and processes for carrying out the several purposes of the present invention.

The various illustrative logical blocks, modules, and algorithm steps described in connection with the examples disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing any departure from the scope of the disclosure.

It will also be understood that the system according to the present disclosure may be, at least partly, implemented on a suitably programmed computer. Likewise, the present disclosure contemplates a computer program being readable by a computer for executing the method of the invention. The present disclosure further contemplates a non-transitory computer-readable memory tangibly embodying a program of instructions executable by the computer for executing the method of the present disclosure.

Also, it is to be understood that the phraseology and terminology employed herein are for the purpose of description and should not be regarded as limiting.

It should be noted that the words “comprising”, “including” and “having” as used throughout the appended claims are to be interpreted to mean “including but not limited to”. The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases, and disjunctively present in other cases.

It is important, therefore, that the scope of the invention is not construed as being limited by the illustrative examples set forth herein. Other variations are possible within the scope of the present invention as defined in the appended claims. Other combinations and sub-combinations of features, functions, elements and/or properties may be claimed through amendment of the present claims or presentation of new claims in this or a related application. Such amended or new claims, whether they are directed to different combinations or directed to the same combinations, whether different, broader, narrower or equal in scope to the original claims, are also regarded as included within the subject matter of the present description.

It is expected that during the life of a patent maturing from this application many relevant lightweight batteries will be developed and the scope of the terms battery and Lithium battery is intended to include all such new technologies a priori.

It is expected that during the life of a patent maturing from this application many relevant direction changing components will be developed and the scope of the term direction changing component is intended to include all such new technologies a priori.

It is expected that during the life of a patent maturing from this application many relevant control actuators for direction changing components will be developed and the scope of the term control actuator for a direction changing component is intended to include all such new technologies a priori.

As used herein with reference to quantity or value, the term “approximately” means “within ±50% of”.

The terms “comprising”, “including”, “having” and their conjugates mean “including but not limited to”.

The term “consisting of” is intended to mean “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a unit” or “at least one unit” may include a plurality of units, including combinations thereof.

The word “example” is used herein to mean “serving as an example, instance or illustration”. Any embodiment described as an “example” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the disclosure may include a plurality of “optional” features unless such features conflict.

Unless otherwise indicated, numbers used herein and any number ranges based thereon are approximations within the accuracy of reasonable measurement and rounding errors as understood by persons skilled in the art.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

Although the disclosure has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A laser weapon system comprising:
a case comprising:
a battery;
an inverter for converting alternating current electricity to direct current for charging the battery;
a laser emitter; and
a power control module for controlling provision of power from the battery to the laser emitter;
a directional component for directing laser output to a specific direction and for focusing the laser output;
an aiming component attached to the directional component for aiming the laser output; and
a fiber optic cable attached to the case and to the directional component for transferring laser radiation from the case to the directional component,
wherein:
the case is arranged for passive cooling of the laser emitter; and
the aiming component comprises a range finder for measuring a range to a target and providing the range to automatic laser focusing optics in the directional component for focusing the laser output at the measured range.

2. A laser weapon system according to claim 1 comprising an automatic laser directing component producing an electronic signal indicating what correction is needed to move the laser output to a location where the laser output was initially imaged.

3. A laser weapon system according to claim 2 arranged to receive the electronic signal and wherein the directional component comprises components for automatically correcting a direction of the laser output based on the electronic signal.

4. A laser weapon system according to claim 1 wherein the case weighs less than 30 kilograms.

5. A laser weapon system according to claim 1 wherein the output laser power is at least 1 kilo-Watt [kW] Continuous Wave (CW).

6. A laser weapon system according to claim 1 wherein the case is arranged for passive cooling of the laser emitter by an electric fan blowing air out of a bottom portion of the case when the case is carried on an operator's back.

7. A laser weapon system according to claim 1 wherein the aiming component comprises a digital camera and a display.

8. A laser weapon system according to claim 1 wherein the aiming component comprises a night vision device.

9. A laser weapon system according to claim 1 wherein the aiming component comprises a flashlight.

10. A laser weapon system according to claim 1 and further comprising a laser control module for controlling whether the laser emitter produces the laser output, and wherein the laser control module receives a signal from a laser trigger in the laser weapon system and from a receiver in the laser weapon system, and controls whether the laser emitter produces the laser output based on a combination of the signal from the laser trigger and a signal from the receiver.

11. A method of using a laser weapon system comprising:
providing a case comprising:
a battery;
an inverter for converting alternating current electricity to direct current for charging the battery;
a laser emitter; and
a power control module for controlling provision of power from the battery to the laser emitter;
providing a directional component for directing laser output to a specific direction and for focusing the laser output;
providing an aiming component attached to the directional component for aiming the laser output;
providing a fiber optic cable attached to the case and to the directional component for transferring laser radiation from the case to the directional component;
using a range finder comprised in the aiming component for measuring a range to a target;
providing the range to automatic laser focusing optics in the directional component for focusing the laser output at the measured range; and
using the automatic laser focusing optics to focus the laser output at the measured range.

12. A method of using a laser weapon system comprising:
providing an automatic laser directing component comprised in an aiming component of a laser weapon system, for tracking an image of a laser spot on an image of a target and producing an electronic signal indicating what direction correction is needed to move the laser spot to an initial location where the laser spot was initially imaged;
providing a directional component for changing a direction of an output laser beam of the laser weapon system based on the electronic signal;
using the automatic laser directing component to produce an initial image of the laser spot on the target;
using the automatic laser directing component to produce an additional image of the laser spot on the target;
producing an electronic signal indicating what direction correction is needed to move the laser spot from the location in the additional image to the location where the laser spot was initially imaged; and
using the directional component to change the direction of the output laser beam of the laser weapon system so that the laser spot is directed to the initial location.
